(19) United States
(12) Patent Application Publication
(10) Pub. No.: US 2023/0205204 A1
(43) Pub. Date: Jun. 29, 2023

(54) METHOD FOR CONTROLLING A ROBOT-AIRCRAFT AND CORRESPONDING CONTROL SYSTEM

(71) Applicant: THALES, COURBEVOIE (FR)

(72) Inventors: Laurent LALUQUE, MERIGNAC (FR); Sylvain LISSAJOUX, TOULOUSE CEDEX 1 (FR); Patrick GOUHIER, TOULOUSE CEDEX 1 (FR); Bruno CAPELLE, MERIGNAC (FR)

(21) Appl. No.: 17/923,488

(22) PCT Filed: May 3, 2021
(86) PCT No.: PCT/EP2021/061576

§ 371 Date: Nov. 4, 2022

(30) Foreign Application Priority Data
May 5, 2020 (FR) 2004418

(51) Int. Cl. G05D 1/00; B64U 10/00

(52) U.S. Cl. CPC G05D 1/0055; G05D 1/0088; B64U 10/00; B64U 2201/10

(57) ABSTRACT

Method for controlling an unmanned aircraft piloted by a fully autonomous control system including a first decision module and a simplex piloting control module including a high-performance controller, a high-safety controller and a second decision module, the high-performance and high-safety controllers determining piloting commands for the robot-aircraft, according to which: —as long as a set of conditions is verified, implementation by the first decision module of a nominal piloting mode with delivery to the output of the automatic control system of the piloting commands delivered to the output of the simplex piloting control module; —otherwise, switching to an emergency piloting mode, an emergency piloting command is delivered to the output of the automatic control system for execution by the robot-aircraft, the first decision module preventing the delivery to the output of the automatic control system of the piloting commands delivered to the output of the simplex module.

### CROSS-REFERENCE TO RELATED APPLICATION(S)

This application is the U.S. national phase of International Application No. PCT/EP2021/061576 filed May 3, 2021, which designated the U.S. and claims priority to FR 2004418 filed May 5, 2020, the entire contents of each of which are hereby incorporated by reference.

### TECHNICAL FIELD OF THE INVENTION

The present invention relates to the field of control of autonomous vehicles, i.e. without a human pilot. The field of application is that of autonomous aircraft, i.e. without any intervention of a human for controlling same during the operation: unmanned aircraft, unmanned drones, unmanned helicopters, etc.

The purpose of such control is to ensure the flight safety of an aircraft. Flight safety means the probability, which is guaranteed, that an event (e.g. accident, incident, failure, etc.) leads to the death or the injury of human persons on board the aircraft or on the ground. In aeronautics, such probability is traditionally associated with a level of risk:

| Level of risk | Classification of the effects of an accident |
|---|---|
| Catastrophic | Loss of aircraft and/or deaths |
| Risky | Reduction of safety margins |
| (Hazardous) | Excessive physical distress or excessive |
| | workload for the crew |
| | Severe injuries or deaths of a few occupants |
| | Significant reduction in safety margins |
| Major | Decrease in the team's ability to cope with |
| (Major) | difficult operational conditions |
| | Severe injuries or deaths of a few occupants |
| Minor | Low reduction in safety margins |
| (Minor) | Slightly increased workload (change of |
| | routines) for the crew |
| | Physical effects but no injuries to occupants |

### BACKGROUND OF THE INVENTION

The methods currently used in the field of unmanned aircraft are flights supervised by an operator along with the automation of aircraft tasks, or are based on mechanisms, the safety of which is currently neither guaranteed nor recognized, using e.g. artificial intelligence e.g. such as machine learning.

### SUMMARY OF THE INVENTION

To this end, according to a first aspect, the invention proposes a method of controlling an unmanned aircraft piloted by a fully autonomous control system comprising a first decision module and a simplex control module comprising a high-performance controller, a high-safety controller and a second decision module, the high-performance and high-safety controllers each determining piloting commands of the unmanned aircraft,

according to which the following steps are implemented by the pilot control simplex module:
a set of safe states which have been predefined, each represented by a state vector comprising a set of parameter(s) of predefined value(s) from a set of parameters characterizing the lateral, vertical and/or longitudinal motion of the unmanned aircraft, determination by the second decision module of the current state of the unmanned aircraft represented by the current state vector comprising the current values of said set of parameters, relating to the unmanned aircraft and determination by the second decision module of whether said determined current state is a safe state comprised of the set of safe states;
if the second decision module has determined that the current state is a safe state, same then selects the current piloting commands provided by the high-performance controller from the commands provided by the high-performance controller and the high-safety controller, the simplex piloting control module then selectively outputting said piloting commands selected for execution by the unmanned aircraft;
if the second decision module has determined that the current state is not a safe state, same then selects the current piloting commands provided by the high-safety controller from the commands provided by the high-performance controller and the high-safety controller for execution by the unmanned aircraft, the simplex piloting control module then selectively outputting said piloting commands selected for execution by the unmanned aircraft;

said method being characterized in that same further comprises the following steps:
monitoring, by the first decision module, that a set of conditions is properly met;
as long as said set of conditions is properly met, implementing by the first decision module of a first mode of piloting of the unmanned aircraft, called the nominal piloting mode, comprising the delivery to the output of the automatic control system of said piloting commands delivered to the output of the simplex piloting control module;
as soon as said set of conditions is no longer met, switchover by the first decision module from the first piloting mode to a second piloting mode, called emergency piloting mode, wherein an emergency command set comprising at least one piloting command is generated by an emergency module in response to said switchover and said emergency command set is output from the automatic control system for execution by the unmanned aircraft, the first decision module preventing the delivery to the output of the automatic control system of the piloting commands delivered to the output of the simplex piloting control module.

The invention thus makes it possible to guarantee the flight safety of an aircraft without the intervention of a human and proposes a completely autonomous solution (i.e. automatic and without supervision by a human) of control making it possible to guarantee that said aircraft remains within an envelope of safe states, considering the state vector.

In some embodiments, a method of controlling an unmanned aircraft according to the invention further includes one or more of the following characteristics:
the unmanned aircraft executes the piloting commands delivered to the output of the control system;
the set of conditions includes one or a plurality of the conditions corresponding to the correct operation of sensors onboard the unmanned aircraft, the availability of data relating to the current area overflown (terrain databases, obstacles, touchdown zones), the presence of at least one predefined touchdown zone at a fixed maximum distance, absence of predefined hardware failures, a current value of speed and/or altitude within a range of predefined values;
the unmanned aircraft is an unmanned helicopter, a fixed-wing unmanned aircraft, a drone, an unmanned aircraft with vertical take-off and vertical landing;
the exclusive distribution of functions between the high-performance controller and the high-safety controller is as follows:
the high-performance controller identifies the landing zone and/or generates the approach path, executes and/or adapts the approach maneuver, and generates corresponding piloting commands of the unmanned aircraft;
the high-safety controller maintains the unmanned aircraft within the flight envelope corresponding to the set of safe states and/or avoids obstacles and/or reboots the high-performance controller and/or navigates and lands on a predefined terrain and generates corresponding piloting commands for the unmanned aircraft;
the lateral, vertical, and/or longitudinal motion parameters comprise parameters such as speed, acceleration and/or heading of the unmanned aircraft in the lateral, vertical, and/or longitudinal plane, respectively.

According to a second aspect, the present invention proposes a control system suitable for piloting in an entirely autonomous manner, an unmanned aircraft comprising a first decision module and a simplex control module comprising a high-performance controller, a high-safety controller and a second decision module, the high-performance and high-safety controllers each being suitable for determining piloting commands for the unmanned aircraft, wherein:
a set of safe states which have been predefined, each represented by a state vector comprising a set of parameter(s) of predefined value(s) from a set of parameters characterizing the lateral, vertical and/or longitudinal motion of the unmanned aircraft, the second decision module being suitable for determining the current state of the unmanned aircraft represented by the current state vector comprising the current values of said set of parameters, relating to the unmanned aircraft and for determining whether said determined current state is a safe state comprised of a set of safe states;
if the second decision module has determined that the current state is a safe state, same is suitable for selecting the current piloting commands provided by the high-performance controller from the commands provided by the high-performance controller and the high-safety controller, the simplex piloting control module being suitable for selectively outputting said piloting commands selected for execution by the unmanned aircraft;
if the second decision module has determined that the current state is a safe state, same is suitable for selecting the current piloting commands provided by the high-performance controller from the commands provided by the high-performance controller and the high-safety controller for the execution by the unmanned aircraft, the simplex piloting control module being suitable for selectively outputting said piloting commands selected for execution by the unmanned aircraft;

said system being characterized in that:
the first decision module is suitable for monitoring that a set of conditions is properly met;
as long as said set of conditions is properly met, the first decision module is suitable for implementing a first mode of piloting of the unmanned aircraft, called the nominal piloting mode, including the delivery to the output of the automatic control system of said piloting commands delivered to the output of the simplex piloting control module;
as soon as said set of conditions is no longer met, the first decision module is suitable for triggering a switchover from the first piloting mode to a second piloting mode, called emergency piloting mode, wherein an emergency module is suitable for generating an emergency command set comprising at least one piloting command in response to said switchover, the automatic control system being suitable for supplying to the output, said emergency command set for execution by the unmanned aircraft, the first decision module being suitable for preventing the delivery to the output of the automatic control system of the piloting commands delivered to the output of the simplex piloting control module.

In some embodiments of the control system:
the set of conditions includes one or a plurality of the conditions corresponding to the correct operation of sensors on board the unmanned aircraft, the availability of data relating to the current area overflown (terrain databases, obstacles, touchdown zones), the presence of at least one predefined touchdown zone at a fixed maximum distance, absence of predefined hardware failures, a current value(s) of speed and/or altitude within a range of predefined values; and/or
the lateral, vertical, and/or longitudinal motion parameters comprise parameters such as speed, acceleration and/or heading of the unmanned aircraft in the lateral, vertical, and/or longitudinal plane, respectively.

According to another aspect, the invention proposes an unmanned aircraft comprising a control system according to the previous aspect of the invention, said unmanned aircraft being suitable for executing the piloting commands delivered to the output of the control system.

### BRIEF DESCRIPTION OF THE DRAWINGS

The features and advantages of the invention will appear upon reading the following description, given only as an example, and making reference to the enclosed drawings, wherein:

FIG. 1 is a schematic view of an unmanned helicopter according to an embodiment of the invention;

FIG. 2 is a schematic view illustrating the simplex operation mode according to an embodiment of the invention;

FIG. 3 is a state diagram according to an embodiment of the invention;

FIG. 4 shows the steps of a piloting control method according to an embodiment of the invention;

### DETAILED DESCRIPTION OF SOME EMBODIMENTS

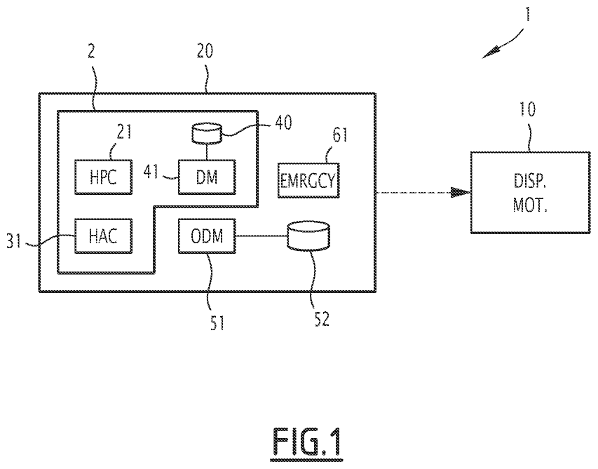

FIG. 1 shows an unmanned aircraft 1, also called autonomous aircraft 1, herein an unmanned helicopter, i.e. a helicopter without pilot and, furthermore, not operated remotely by a human operator.

The unmanned helicopter 1 comprises, among others, a piloting control system 20 and a set of equipment, referred herein globally by the all-encompassing name “control and actuator device” 10.

The control and actuator device 10 comprises all the equipment of the unmanned helicopter 1 generating the motion of the unmanned helicopter: the engines, the rotor blades, the mobile parts of the unmanned helicopter influencing the dynamics thereof, the altitude thereof, the orientation thereof, the speed thereof, the acceleration thereof. The control and actuator device 10 includes at least the equipment for implementing flight commands (real-time electronic calculation platform). Depending on the aircraft, the aircraft could further include a part or all of the (mechanical or electrical) actuators for e.g. moving the aerodynamic control surfaces, engine controllers (e.g. control of the power delivered, of the speeds of rotation or of the pitch of the propellers) or further any control device specific to the carrier, as well as any electronic feedback device.

The piloting control system 20 is suitable for automatically determining piloting commands and providing same to the control and actuator device 10 which then executes same: such commands thus comprise flight commands (i.e. speed, altitude, attitude), as well as heading commands, etc.

The control system 20 comprises a simplex piloting module 2, a mode switchover module 51, labeled ODM 51 module, and an emergency module, called EMRGCY 61 module.

The simplex piloting module 2 is a module for determining piloting commands intended for the drive device 10. The simplex piloting module 2 has a simplex architecture. Such architecture, used in critical systems for calculating the system commands, is described e.g. in the document “Using Simplicity to Control Complexity”, Lui Sha et al., 2001. The simplex architecture keeps the controlled system within a safe envelope.

The simplex piloting module 2 includes:
a “high-performance” control controller 21, also called HPC 21;
a “high-safety” pilot controller 31, also called HAC 31;
a decision module 41, also called DM 41.

Each of the piloting controllers HPC 21 and HAC 31 being in parallel with each other, suitable for determining piloting commands for the control and actuator device 10, according to data provided to same by a set of sensors and according to a mission to be carried out by the autonomous aircraft 1 (e.g. a route to be followed, a camera view to be taken, a load transport, a visual inspection, a hunting of a car).

The set of sensors comprises, according to the embodiments, one or a plurality of sensors among sensors:
suitable for perceiving the external environment, such as a laser remote sensing device, better known as lidar (light detection and ranging); a radar (radio detection and ranging); a laser (light amplification by stimulated emission of radiation); a rangefinder; a radio altimeter; or any other viewing device such as one or a plurality of stereoscopic cameras; and/or
suitable for estimating the physical characteristics of the autonomous aircraft 1 (position, speed, acceleration and attitudes), such as an accelerometer; an inertial unit, also called IMU (Inertial Measurement Unit); a Doppler effect sensor; a satellite positioning sensor, such as a GPS (Global Positioning System) sensor, a Galileo sensor, a Glonass sensor; and/or
suitable for perceiving the mass of air wherein the autonomous aircraft 1 is moving, such as incidence probes, pressure sensors (Air data unit) or a weather radar.

Such sensors are carried on board the autonomous aircraft 1 or outside the latter.

The HAC controller 31 can also use as input, the commands determined by the HPC 21 controller.

Typically the HPC 21 is suitable for having the function of calculating commands from inputs, all with a performance goal—with high-performance technology such as neural networks or evolutionary algorithms, while the HAC 31 is suitable for performing the same function of calculating commands from inputs, with safety goals, the HAC 31 having been certified, in one embodiment, with regard to flight safety (designed and certified for achieving the goals thereof with a standard level of safety). The HAC 31 can also perform a simpler function than the HPC 21 making it possible only to protect the aircraft.

Within the calculation of commands for carrying out the mission, e.g. the monitoring of a predefined route, the HPC 21 takes into account passenger comfort, the minimization of fuel consumption, etc., while the HAC 31 makes sure to avoid obstacles and loss of control, without taking into account fuel aspects or comfort.

A state vector is associated with the autonomous aircraft 1, which comprises parameters, in the vertical plane and/or the longitudinal plane and/or the lateral plane, the value of which characterizes the current state of the aircraft 1 and/or the motion in each of said planes.

In the longitudinal plane, the parameters of the state vector can be the position of the autonomous aircraft 1, the longitudinal speed (such as calibrated AirSpeed, True AirSpeed, Mach, IAS, Ground Speed, etc.) thereof, and/or the longitudinal acceleration thereof, etc.

In the lateral plane, the parameters of the state vector can be the lateral speed of the autonomous aircraft 1, the lateral acceleration thereof, the lateral load factor, and/or the attitudes of the aircraft 1 in said plane (roll, yaw, sideslip, heading, route) etc.

In the vertical plane, the parameters of the state vector can be the altitude of the autonomous aircraft 1, the vertical speed thereof, the vertical acceleration thereof, the vertical load factor, and/or the attitudes of the aircraft 1 in said plane (pitch, incidence, vertical attitude) etc.

Optionally, a height from the ground, or more generally a distance/direction pair to the nearest obstacle completes the state vector.

The simplex control module 2 is further associated with a set of predefined safe states 40. The set of predefined safe states comprises the definition of one or a plurality of safe states, each safe state being represented by a state vector the parameters of which take respective predefined values, within a range of respective predefined values in each plane considered amongst the vertical, lateral, longitudinal planes.

The range of predefined values is e.g. generated with regard to the mission: e.g., with regard to attitudes, the heading value could be limited to a deviation of a few degrees (e.g. a deviation of a set value, less than or equal to 10°) with a theoretical heading that the unmanned aircraft should then have according to the mission thereof.

The decision module 41, also called DM 41, is suitable for determining the current state of the unmanned aircraft 1, defined by the current state vector, i.e. e.g. by the current speed, the current acceleration and the current heading difference in each plane considered. The DM 41 is suitable for comparing the current state of the unmanned aircraft with the safe state set 41 and thus for determining, based on the comparison, whether the current state is part of the safe states or not (i.e. if the current state vector is equal to one of the safe state vectors).

The DM 41 is suitable, if the current state is not one of the safe states, for selecting the current piloting commands provided by the HAC 31 controller from the current piloting commands provided by the HPC 21 controller and the HAC 31 controller, and for delivering said selected commands to the output of the simplex control module 2.

The DM 41 is suitable, if the current state is one of the safe states, for selecting the current piloting commands provided by the HPC 21 controller from the current piloting commands provided by the HPC 21 controller and the HAC 31 controller, and for delivering said selected commands to the output of the simplex control module 2.

To do this, in an embodiment with reference to FIG. 1, the simplex drive control module 2 comprises a switch 9 and the DM 41 is suitable for piloting the switch 9 so as to link the HPC 21 when a safe state has been determined and alternatively so as to link the HAC 21 when an unsafe state has been determined.

In one embodiment, the simplex pilot control module 2 further implements an adaptive control method such as the L1 simplex, which can be used for detecting that the aircraft control model is changing which is e.g. the case during a failure (e.g. an engine failure), or during extreme aerology phenomena (e.g. turbulence generating a stall or windshear).

The simplex piloting module 2 thus makes it possible, as soon as the unmanned aircraft is no longer in a safe state such as predefined, to give piloting back to the higher safety HAC controller 31, until the latter has re-established the unmanned aircraft 1 in a safe state.

The mode switchover module 51, also called the ODM module 51, is suitable for monitoring a set of conditions 52, called the set of nominal operating conditions 52, and for immediately detecting that the set of nominal conditions is no longer met.

The ODM module 51 is, as long as same detects that the set of nominal operating conditions 52 is fulfilled, suitable for providing to the control and actuator device 10, the current commands determined by the simplex automatic piloting module 2 and intended for the control and actuator device 10: this is the nominal operating mode of the piloting control system 20. The ODM module 51 is, upon detection that the set of nominal operating conditions 52 is no longer fulfilled, suitable for preventing the provision to the control and actuator device 10 of the current commands determined by the simplex control module 2, and for commanding the EMRGCY 61 emergency module to implement an emergency procedure, giving rise to emergency commands which are then provided to the control and actuator device 10: this is the emergency mode of operation of the piloting control system 20.

In the embodiment considered, the set of nominal operating conditions 52 is defined by one or a plurality of the following parameters:
Current flight conditions—external to the aircraft 1—ensuring a proper operation of the sensors: e.g. external temperature range, wind speed and wind direction, luminance, visibility (RVR), rain;
availability of data relating to the current area overflown (terrain databases, obstacles, touchdown zones);
presence of at least one predefined touchdown zone at less than x NM (NM for Nautical Mile unit), x is e.g. within the range [1, 10];
state of proper operation (according to predefined criteria) of the equipment of the autonomous aircraft 1, in particular of the control and actuator device 10 and in particular of the simplex control module 2; absence of serious hardware failures, i.e. which would have an impact on the mission;
current values of speed and/or altitude etc. within respective ranges of values as predefined by the aircraft manual and by the sensor limitations.

The control and actuator device 10 is suitable for executing the commands provided thereof as input: thus, under the arbitration of the ODM module 51, the control and actuator device 10 is suitable for executing the commands provided by the simplex control module 2 in the nominal operating mode and for executing the emergency commands in the emergency mode.

The EMRGCY 61 emergency module is, in the emergency mode of operation, suitable for sending emergency commands to the control and actuator device 10 allowing the unmanned aircraft to be placed in a state of minimum risk: such emergency controls comprising e.g. an immediate landing command, or a command to land on the nearest emergency zone from a predefined list of emergency zones, or e.g., when the aircraft is a helicopter, an autorotation maneuver in the event of an engine failure.

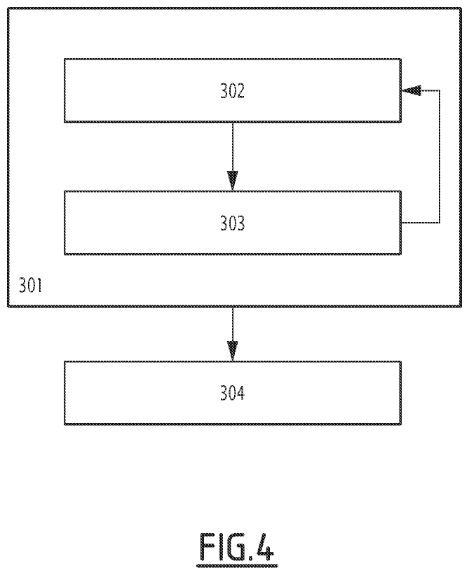

The steps of a method 300 for controlling the piloting of an autonomous aircraft 1 in an embodiment of the invention are now described with reference to FIG. 4 Such steps describe the automatic determination of the piloting commands by the piloting control system 20, according to the context and the provision of the commands which have then to be applied to the control and actuator device 10 depending on the state (safe/unsafe and according to the nominal operating mode or the emergency mode).

In a set of steps 301, the following steps are implemented, the ODM 51 module monitoring the set of nominal operating conditions 52 (e.g. at a frequency comprised in the range 0.1 to 1000 Hz):
As long as each of the conditions of the set of the conditions 52 is fulfilled, the piloting control system 20 operates in a nominal operating mode, wherein the ODM 51 makes it possible that the pilot commands determined by the simplex pilot module 2, as described below with respect to steps 302, 303, are actually delivered to the engine system 10.

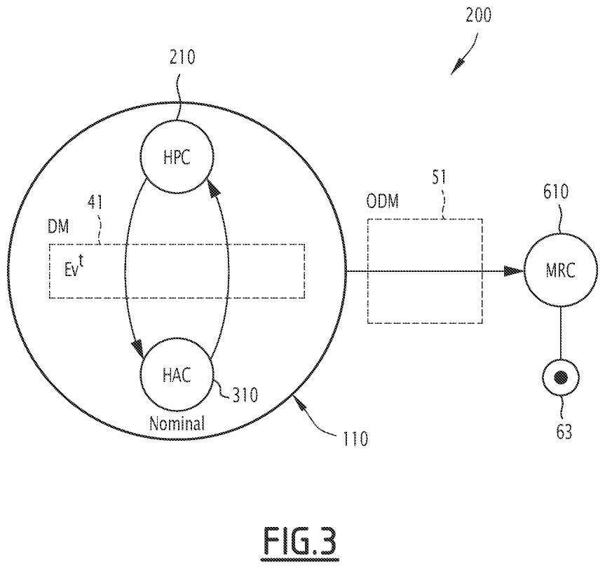

FIG. 3 shows a state machine diagram illustrating the operation of the piloting control system 20. The nominal operating mode corresponds to the state 110.
As soon as the ODM module 51 detects, that the set of nominal conditions 52 is no longer met (e.g. outside temperature too cold, no data available on the presence of obstacles near the unmanned aircraft, no predefined touchdown zone within the prescribed perimeter, serious hardware failure, altitude outside the permitted range, etc.), same triggers the switchover of the piloting control system 20 from the nominal operating mode to an emergency operating mode: the ODM 51 module henceforth prevents the delivering to the control and actuator device 10 of the current commands determined by the simplex piloting module 2, and controls the implementation of an emergency procedure by the EMRGCY 61 emergency module, as described in relation to step 304 below.

The emergency mode of operation corresponds to the state 610 in the state machine diagram shown in FIG. 3.

The nominal operating mode is an operating mode corresponding to the simplex architecture of the simplex piloting module 2.

In the nominal operating mode, each of the piloting controllers HPC 21 and HAC 31, in parallel with each other, determines piloting commands for the control and actuator device 10, depending on the data provided to same by the set of sensors, whether or not on board the unmanned aircraft) and depending on the mission of the unmanned aircraft 1. The refresh frequency of such commands is e.g. comprised in the range 0.1 to 1000 Hz.

In the nominal operating mode, the decision module 41, DM 41 determines, e.g. at a frequency comprised in the range 0.1 to 1000 Hz, the current state of the unmanned aircraft 1, defined by the current state vector comprising the following terms relating to the unmanned aircraft 1: the current speed thereof, the current acceleration thereof and the current heading difference. The DM 41 compares the current state of the robot aircraft with the safe state set 40:

If the current state is not part of the safe states, in a step 303, the DM 41 then selects the current piloting commands provided by the HAC controller 31 from among the current piloting commands provided by the HPC 21 controller and the HAC 31 controller and commands the delivery of said selected commands to the output of the simplex piloting control module 2.

In the nominal operating mode, the control and actuator device 10 then executes such commands (the state 310 of the state machine in FIG. 3).

If the current state is part of the safe states, in a step 302, the DM 41 then selects the current piloting commands provided by the HPC 21 controller from among the current piloting commands provided by the HPC 21 controller and the HAC 31 controller and commands the delivery of said selected commands to the output of the simplex piloting control module 2. In the nominal operating mode, the control and actuator device 10 then executes such commands (the state 210 of the state machine in FIG. 3).

The choice made by the DM 41 e.g., gives rise to the piloting of the switch 9 so as to connect the output of the simplex piloting control module 2 and the output of the HPC 21 when a safe state has been determined and alternatively, so as to connect the HAC 21 and the output of the simplex piloting control module 2 when an unsafe state has been determined.

Thus, in the nominal operating mode, in the safe states, piloting is provided by the HPC 21, the HAC taking over the control as soon as the unmanned aircraft has left all the safe states and keeping the control until the unmanned aircraft returns to a safe state.

As soon as the operation is switched over to the emergency operation mode, in a step 304, the emergency module EMRGCY 61 then supplies emergency commands to the control and actuator device 10 which executes same (state 610 of the state machine of FIG. 3), placing the unmanned aircraft in a Minimum Risk Condition (MRC) 63: the emergency commands comprise e.g. an immediate landing command, or a command to land on the nearest emergency zone, etc.

In one embodiment, the control system 20 is onboard the unmanned aircraft 1. It is recalled that an unmanned aircraft is characterized by the fact that same has no human pilot nor remote human operator.

In some embodiments, the HPC and/or DM are not onboard, and are on the ground.

The solution according to the invention described with reference to FIGS. 1-3 is, e.g. in an embodiment, implemented by an unmanned aircraft such as an unmanned helicopter, in the landing phase.

In the context of such landing phase, the blocks shown in FIG. 3 are suitable for performing the following functions and for generating the corresponding piloting commands:
HPC 21: identification of the landing zone, generation of the approach path, execution and adaptation of the maneuver, generation of the corresponding commands for the control and actuator device 10 of the unmanned helicopter;
HAC 31: maintaining the helicopter within the flight envelope (corresponding to the set of safe states 40, avoidance of obstacles, rebooting the HPC 21, navigation and landing on a predefined terrain, generation of the corresponding commands intended for the control and actuator device of the unmanned helicopter;
DM 41 block: detection of loss of control, attitude, unusual speed for a landing, detection of impact on a terrain, detection of a malfunction of the HPC 21 controller, switchover between the HPC 21 and the HAC 31;
ODM 51 block: detection of the correct operation of the systems and of the defined conditions of operation of the sensors (lighting, temperature, etc.)
EMRGCY 61 block: implementation of emergency procedures for responding to the emergency situations and generation of corresponding commands for the control and actuator device 10 of the unmanned helicopter; such situations are for an unmanned helicopter and more generally for an unmanned aircraft, an unserviceable engine, a landing on water, a fire, a hydraulic problem.

It should be noted that, outside of the landing phase, the state vector further comprises a parameter relating to a distance with respect to the environment (a safe state corresponds to a minimum guard distance).

The equipment used by such blocks for performing such functions includes e.g.:
HPC 21: wide choice of sensors (cameras, radars, etc.) including the sensors of the HAC 31 and others, data fusion, databases, artificial intelligence and machine learning, high connectivity and significant computing resources (in comparison with the resources of the HAC 31);
HAC 31: certified block comprising a flight navigator with certified safety but with reduced performance, low precision sensors, sudden avoidance maneuvers;
DM 41 block: certified block, reduced number of sensors (“aeronautical sensors for localization (such as GADIRS comprising satellite positioning sensors (GPS, GNSS, etc.) and/or baro-inertial) for monitoring speed, acceleration, attitude of the unmanned helicopter; “reliable” sensors for obstacle detection, such as LIDAR/RADAR, e.g. “overhead wires detection” at 600 feet from the aircraft 1, basic rules for switchover decision between HPC 21 and HAC 31.

In one embodiment, the control system 20 comprises a processor 14 and a memory 15. The memory 15 comprises software instructions which, when executed on the processor 14, automatically implement the steps described with reference to FIG. 4 and incumbent upon one or a plurality of the blocks amongst the control system 20, the simplex piloting module 2, HPC 21, HAC 31, DM 41, ODM 51, the EMRGCY 61.

In another embodiment (not shown), one or each of said blocks is produced in the form of a programmable logic component, such as an FPGA (Field Programmable Gate Array), or further in the form of a dedicated integrated circuit, such as an ASIC (Application Specific Integrated Circuit).

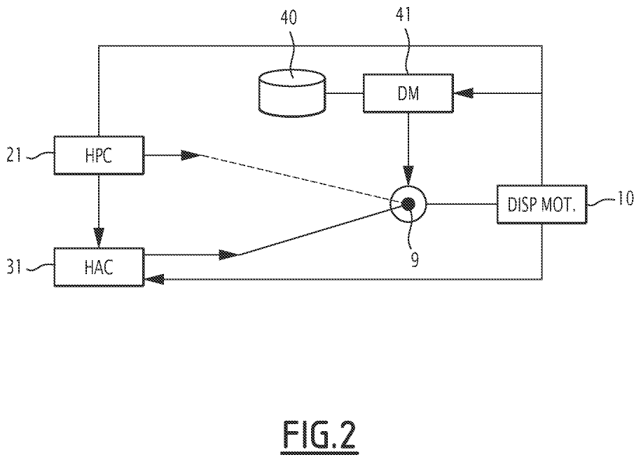

In one embodiment, in a prior design step, the following steps are implemented for defining the functions of each block shown in FIG. 2, as defined above.

Thus, for the DM 41 and HAC 31 blocks:
a/ identification of feared events (example: hitting a tree);
b/ identification of the recovery conditions (resumption of HAC when the HPC is on command; and vice versa) (example: avoiding the tree);
c/ identification of observable data (data relating to all unmanned aircraft systems, aerodynamics, mission)—and thus definition of sensors—for detecting said events (example: a radar or a lidar, or a camera is needed for observing a tree);
d/ definition of the “generic” functions of the HAC 31 controller: the functions essential for maintaining the aircraft in a safe state (example: keeping the aircraft at a safe distance from trees);

for the ODM 51 and EMRGCY 61 blocks:
e/ identification of feared events (i.e. which trigger the transition from the nominal simplex operation to emergency operation);
f/ Functional Hazard Analysis (FHA) evaluation, which depends on the properties of the HAC 31 controller and the control device 10 (example: engine failure);
g/ identification of observable data (data relating to all the unmanned aircraft systems, and to the external environment thereof—and thus definition of sensors—for detecting such events (example: engine fuel/power supply);
h/ definition of emergency functions, i.e. maneuvers which will put the aircraft in a minimum risk condition given the state thereof and the environment thereof (e.g. putting the unmanned helicopter in autorotation if the unmanned aircraft is an unmanned helicopter);

for the HPC 21 and HAC 31 blocks:
i/ definition of the functionalities of the HPC 21 controller block (example: controlling the unmanned aircraft with a maximum speed so as to decrease the travel time);
j/ for each of the feared events identified in a/, definition of the specific functions of the HAC 31 controller (example: for the feared event “avoiding a tree”, defining the command that passes, from a fast-speed flight to avoiding the tree in a safe way: minimum distance, maximum speed).

Such steps make it possible in particular, to define the functions of the blocks described hereinabove by considering the landing phase of an unmanned aircraft.

In one embodiment, the simplex control module 2 was designed taking into account the constraint of guaranteeing the flight safety of the unmanned aircraft: flight safety means the probability that a feared event will lead to the death of the passengers of the robot aircraft or to the death of humans on the ground; certification corresponds to a commitment [with regard to the] occurrence of such feared events. With regard to what depends on HAC—and partially on DM—(the process relating to HPC will be more focused on the successful execution of the mission), the following process has been implemented:
Identification of feared events (e.g. striking the ground, losing a propeller, etc.);
Identification of a countermeasure for responding to such an event (mitigation principle);
Construction of a failure tree (tree comprising all source events leading to the feared event, with a probability of occurrence of each of said source events, thus determining the probability of occurrence of the feared event);
Requirement allocation (i.e. probability of failure assigned to the different modules depending on the level of occurrences of the feared events on which the certification commitment was made).

According to the invention, a machine is in charge of safety onboard and guarantees that the unmanned aircraft remains within an envelope of safe states: according to the invention, it is guaranteed, in a completely autonomous manner with regard to automatic piloting, that the state vector will not leave the envelope of safe states.

The application of the solution to an unmanned aircraft, in particular an unmanned helicopter, has been described hereinabove, but the invention can of course be applied to any type of autonomous vehicle, without a human pilot or a remote human operator: e.g., an unmanned fixed-wing aircraft, a drone, an unmanned aircraft with vertical take-off and vertical landing, etc.

1. A method for controlling an unmanned aircraft piloted by a fully autonomous control system comprising a first decision module and a simplex piloting control module comprising a high-performance controller, a high-safety controller and a second decision module, the high-performance and high-safety controllers each determining piloting commands for the robot-aircraft,
wherein the following steps are implemented by the simplex piloting control module:
a set of safe states which have been predefined, each represented by a state vector comprising a set of parameter(s) of predefined value(s) from a set of parameters characterizing the lateral, vertical and/or longitudinal motion of the unmanned aircraft, determination by the second decision module of the current state of the unmanned aircraft represented by the current state vector comprising the current values of said set of parameters, related to the unmanned aircraft and determination by the second decision module of whether said determined current state is a safe state comprised within the set of safe states;
if the second decision module has determined that the current state is a safe state, the second decision module then selects the current piloting commands provided by the high-performance controller from the commands provided by the high-performance controller and the high-safety controller, the simplex piloting control module then selectively outputting said piloting commands selected for execution by the unmanned aircraft;
if the second decision module has determined that the current state is not a safe state, the second decision module then selects the current piloting commands provided by the high-safety controller from the commands provided by the high-performance controller and the high-safety controller for execution by the unmanned aircraft, the simplex piloting control module then selectively outputting said piloting commands selected for execution by the unmanned aircraft;
wherein said method further comprises the following steps:
monitoring, by the first decision module, that a set of conditions is properly met;
as long as said set of conditions is properly met, implementing by the first decision module of a first mode of piloting of the unmanned aircraft, called the nominal piloting mode, comprising the delivery to the output of the automatic control system, of said piloting commands delivered to the output of the simplex piloting control module;
as soon as said set of conditions is no longer met, switchover by the first decision module from the first piloting mode to a second piloting mode, called emergency piloting mode, wherein an emergency command set comprising at least one piloting command is generated by an emergency module in response to said switchover and said emergency command set is output from the automatic control system for execution by the unmanned aircraft, the first decision module preventing the delivering to the output of the automatic control system of the piloting commands delivered to the output of the simplex piloting control module.

2. The method of controlling an unmanned aircraft according to claim 1, wherein the unmanned aircraft executes the piloting commands delivered to the output of the control system.

3. The method of controlling an unmanned aircraft according to claim 1, according to which the set of conditions includes one or more of conditions corresponding to proper operation of sensors on board the unmanned aircraft, the availability of data relating to the current area overflown, the presence of at least one predefined landing zone at a fixed maximum distance, absence of predefined hardware failures, a current value of speed and/or altitude within a range of predefined values.

4. The method of controlling an unmanned aircraft according to claim 1, wherein the unmanned aircraft is an unmanned helicopter, a fixed-wing unmanned aircraft, a drone, an unmanned aircraft with vertical take-off and vertical landing.

5. The method of controlling an unmanned aircraft according to claim 4, according to which the exclusive distribution of functions between the high-performance controller and the high-safety controller is as follows:
the high-performance controller identifies the landing zone and/or generates the approach path, executes and/or adapts the approach maneuver, and generates corresponding piloting commands of the unmanned aircraft;
the high-safety controller maintains the unmanned aircraft within the flight envelope corresponding to the set of safe states and/or avoids obstacles and/or reboots the high-performance controller and/or navigates and lands on a predefined terrain and generates corresponding piloting commands of the unmanned aircraft.

6. The method for controlling an unmanned aircraft according to claim 1, according to which the lateral, vertical, and/or longitudinal motion parameters comprise parameters of type: speed, acceleration and/or heading of the unmanned aircraft in the lateral, vertical, and/or longitudinal plane, respectively.

7. A control system suitable for fully autonomously piloting an unmanned aircraft comprising a first decision module and a simplex piloting control module comprising a high-performance controller, a high-safety controller and a second decision module, the high-performance and high-safety controllers being each suitable for determine piloting commands for the robot aircraft, wherein:
a set of safe states which have been predefined, each represented by a state vector comprising a set of parameter(s) of predefined value(s) from a set of parameters characterizing the lateral, vertical and/or longitudinal motion of the unmanned aircraft, the second decision module being suitable for determining the current state of the unmanned aircraft represented by the current state vector comprising the current values of said set of parameters, related to the unmanned aircraft and for determining whether said determined current state is a safe state comprised within the set of safe states;
if the second decision module has determined that the current state is a safe state, the second decision module is suitable for selecting the current piloting commands provided by the high-performance controller from the commands provided by the high-performance controller and the high-safety controller, the simplex piloting control module being suitable for selectively outputting said piloting commands selected for execution by the unmanned aircraft;
if the second decision module has determined that the current state is a safe state, the second decision module is suitable for selecting the current piloting commands provided by the high-performance controller from the commands provided by the high-performance controller and the high-safety controller for an execution by the unmanned aircraft, the simplex piloting control module being suitable for selectively outputting said piloting commands selected for execution by the unmanned aircraft;
wherein:
the first decision module is suitable for monitoring that a set of conditions is properly met;
as long as said set of conditions is properly met, the first decision module is suitable for implementing a first mode of piloting of the unmanned aircraft, called the nominal piloting mode, including the delivery to the output of the automatic control system of said piloting commands delivered to the output of the simplex piloting control module;
as soon as said set of conditions is no longer met, the first decision module is suitable for triggering a switchover from the first piloting mode to a second piloting mode, called emergency piloting mode, wherein an emergency module is suitable for generating an emergency command set comprising at least one piloting command in response to said switchover, the automatic control system being suitable for outputting said emergency command set for execution by the unmanned aircraft, the first decision module being suitable for preventing the delivering to the output of the automatic control system of the piloting commands delivered to the output of the simplex control module.

8. The system for controlling an unmanned aircraft according to claim 7, wherein the set of conditions includes one or more of conditions corresponding to proper operation of sensors on board the unmanned aircraft, the availability of data relating to the current area overflown, the presence of at least one predefined landing zone at a fixed maximum distance, absence of predefined hardware failures, a current value of speed and/or altitude within a range of predefined values.

9. The system for controlling an unmanned aircraft according to claim 7, wherein the lateral, vertical, and/or longitudinal motion parameters comprise speed, acceleration and/or heading parameters of the unmanned aircraft in the lateral, vertical, and/or longitudinal plane, respectively.

10. An unmanned aircraft comprising a control system according to claim 7, suitable for executing the piloting commands delivered to the output of the control system.

11. The method of controlling an unmanned aircraft according to claim 2, according to which the set of conditions includes one or more of conditions corresponding to proper operation of sensors on board the unmanned aircraft, the availability of data relating to the current area overflown, the presence of at least one predefined landing zone at a fixed maximum distance, absence of predefined hardware failures, a current value of speed and/or altitude within a range of predefined values.

12. The method of controlling an unmanned aircraft according to claim 2, wherein the unmanned aircraft is an unmanned helicopter, a fixed-wing unmanned aircraft, a drone, an unmanned aircraft with vertical take-off and vertical landing.

13. The method of controlling an unmanned aircraft according to claim 3, wherein the unmanned aircraft is an unmanned helicopter, a fixed-wing unmanned aircraft, a drone, an unmanned aircraft with vertical take-off and vertical landing.

14. The method of controlling an unmanned aircraft according to claim 11, wherein the unmanned aircraft is an unmanned helicopter, a fixed-wing unmanned aircraft, a drone, an unmanned aircraft with vertical take-off and vertical landing.

15. The method for controlling an unmanned aircraft according to claim 2, according to which the lateral, vertical, and/or longitudinal motion parameters comprise parameters of type: speed, acceleration and/or heading of the unmanned aircraft in the lateral, vertical, and/or longitudinal plane, respectively.

16. The method for controlling an unmanned aircraft according to claim 3, according to which the lateral, vertical, and/or longitudinal motion parameters comprise parameters of type: speed, acceleration and/or heading of the unmanned aircraft in the lateral, vertical, and/or longitudinal plane, respectively.

17. The method for controlling an unmanned aircraft according to claim 4, according to which the lateral, vertical, and/or longitudinal motion parameters comprise parameters of type: speed, acceleration and/or heading of the unmanned aircraft in the lateral, vertical, and/or longitudinal plane, respectively.

18. The method for controlling an unmanned aircraft according to claim 5, according to which the lateral, vertical, and/or longitudinal motion parameters comprise parameters of type: speed, acceleration and/or heading of the unmanned aircraft in the lateral, vertical, and/or longitudinal plane, respectively.

19. The method for controlling an unmanned aircraft according to claim 11, according to which the lateral, vertical, and/or longitudinal motion parameters comprise parameters of type: speed, acceleration and/or heading of the unmanned aircraft in the lateral, vertical, and/or longitudinal plane, respectively.

20. The method for controlling an unmanned aircraft according to claim 12, according to which the lateral, vertical, and/or longitudinal motion parameters comprise parameters of type: speed, acceleration and/or heading of the unmanned aircraft in the lateral, vertical, and/or longitudinal plane, respectively.
